(19) United States
(12) Patent Application Publication
(10) Pub. No.: US 2019/0161673 A1
(43) Pub. Date: May 30, 2019

(54) Proppant Transport With Low Polymer Concentration Slurry

(71) Applicant: PFP Technology, LLC, Katy, TX (US)

(72) Inventors: Robert McDaniel, Cypress, TX (US); Rasolomiarantsoa Nathalie, Katy, TX (US)

(73) Assignee: PFP Technology, LLC, Katy, TX (US)

(21) Appl. No.: 15/827,043

(22) Filed: Nov. 30, 2017

(51) Int. Cl. C09K 8/90; E21B 43/267; C09K 8/88; C08L 1/08; C08L 33/26; C08K 5/00

(52) U.S. Cl. CPC C09K 8/90; E21B 43/267; C08K 5/0025; C08L 1/08; C08L 33/26; C09K 8/882

(57) ABSTRACT

Proppant transport can be performed with a fluid having: (a) a low concentration of a crosslinkable first polymer, (b) a delayed effect crosslinker, and (c) optionally, a small amount of a second, high molecular weight, friction-reducing polymer composition.

### FIELD OF THE INVENTION

The invention relates to a proppant suspension system of fracturing fluids used to stimulate oil and gas well production.

### BACKGROUND OF THE INVENTION

Generally, a hydraulic fracturing treatment involves pumping a proppant-free, viscous, fluid (known as a “pad”) into a well at a rate that is faster than the fluid can escape into the formation. This difference in flow rates causes the pressure to rise within the formation so that the rock fractures thereby providing pathways for the trapped oil and gas to escape. The fluid usually is aqueous but oil base fluids, emulsions and even foams have been utilized to create and grow a fracture.

The fluid could be either viscous (linear gel or crosslinked) or thin as in a “slick water frac”. The key is to pump at a higher rate than can leak-off (flow out into the reservoir rock). When this happens there is a build-up of pressure at the face exposed to the fracturing fluid. This pressure will continue to increase until it exceeds the forces binding the rock together. At this point the formation rock will “fracture”. Once the fracture is initiated, continued pumping will cause the fracture to grow in length, width and height.

After fracture initiation and during the period of fracture development and growth, solids called proppants are added to the fluid being pumped forming a slurry so that the proppants can be deposited in the created fracture. Multiple stages of slurry injection at increasing pumping rates are common. It is the distribution of the solids in the fracture that will keep the fracture propped open after pumping has ceased and the formation tries to go back to its unstressed position. This “propped” fracture has a conductivity that is significantly higher that the formation rock surrounding it and therefore represents a highly conductive passageway back to the wellbore.

The influence of fluid injection rate and viscosity on the amount of the tensile failure in the rock with natural fractures has been investigated with a variety of accepted models. The models generally agree that for low viscosity fluid, the amount of area failing in shear is dramatically higher than in the case with high viscosity fluids. Their results show that an increase in injection rate (such as with slickwater systems) greatly increases the amount of tensile failure within the model leading potentially to creating more, longer, fractures, while a lower injection rate (such as with gel-based systems) favors the creation of shear failure resulting mostly in opening pre-existing natural fractures. In general, longer fractures that reach further into the rock are better able to reach trapped oil and gas in the field and are thus more desirable than wide, shallow cracks. This is one of the reasons why slickwater systems are often used to activate low permeability formations. The paper written and presented by Maguire and Sikora (McGuire, W. J. and Sikora, V. J. 1960. The Effect of Vertical Fractures on Well Productivity. J Pet Technol 12 (10): 72-74. SPE-1618-G. http://dx.doi.org/10.2118/1618-G.) describes it best. The authors built a model based on electrical concepts. The model indicated that formations having a low natural permeability will respond best to long narrow propped fractures. Formations having a higher level of natural permeability will respond to increased propped fracture to a point but past that point increased propped fracture length will have limited ability to further increase post frac production. Formations having high natural permeability will respond best to fractures having a substantial propped width but are relatively unaffected by increases in propped fracture length. In today's market, virtually all the formations being stimulated would fall into the category of a well with low natural permeability and therefore are responsive to increased propped fracture length.

High-viscosity fracturing uses relatively high concentrations (e.g., within 12 ppt to 20 wt %) of a polymer that is crosslinked to form a viscous polymer gel. This gel tends to result in the creation of relatively wide and significantly shorter fractures than are created when utilizing high-rate, low viscosity fracturing treatments. Crosslinked fluid systems have been utilized that contained polymer concentrations as high as 60-70 ppt but were known to create excessive damage to the formation and proppant pack permeability/conductivity.

High-rate fracturing treatments, called slickwater systems, possess relatively low viscosity that results from the addition of low concentrations a friction reducer or linear gel, e.g., an amount within the range of 0.25 to about 2 gallons/1000 gallons. Such a low viscosity high rate approach will result in creation of a long, relatively thin fracture geometry. Both fracturing approaches have a place in oil and gas production, and each has their own limitations. For example, high-viscosity systems tend to use high amounts of polymeric additives that are costly, can adversely impact the fracture field, and require more substantial efforts to clean the gel from the tiny fissures. High-rate fracturing requires high flowrates, additional pumps equipment, large volumes of water and are harder to contain within the targeted formation.

Linear gel fracturing fluids are formulated with a wide array of different polymers in an aqueous base. Polymers that are commonly used to formulate these linear gels include guar, hydroxypropyl guar (HPG), carboxy methyl guar (CMG), carboxymethyl HPG (CMHPG), and hydroxyethyl cellulose (HEC). These polymers can be utilized in a dry powder form or as part of a suspension in a carrier fluid that hydrates or swells when mixed with an aqueous solution and form a viscous gel. Friction reducers are also provided as emulsions making them easy to meter, pump, and disperse in water. Increased viscosity can be attained with these hydrated, linear, polymers by adding a crosslinking agent that generates a reversible crosslinking reaction. In general, the frac fluid gelling agents are used in amounts of 0.06 to 0.5 wt % for guar, HPG, CMHPG, HEC, and CMHEG, and 0.01 to 0.14 wt % for synthetic polymers. Polyacrylamides have varying chain lengths or molecular weights, and the size or molecular weight of these polymers gives them the friction-reducing properties. With too short a chain length, the polyacrylamides will not provide enough friction reduction. Polyacrylamides with long polymer chain lengths can be broken with exposure to high shear and again provide inadequate friction reduction. Crosslinking gets its increase in viscosity from the creation of a network or structure. While some crosslinked fluid combinations of polymer and crosslinkers can reform after period of high shear rates (guar and borates are an example) others will be permanently damage by periods of high shear.

In slickwater fracturing in shale reservoirs, the mechanism of proppant transport is different. Since slickwater has only a small concentration of polymer, it does not have high viscosity or the structure required to keep the proppant in suspension. In this case, the proppant settles faster under static conditions, and proppant transport may be dominated by the movement of the proppant bank itself. Three proppant transport mechanisms in slickwater have been proposed. At very low velocity, little or no proppant is moved. At higher velocity, proppant grains roll or slide along the surface of the settled proppant bank. At even higher velocity, proppant grains bounce off the surface back into the flow stream. See Liang et al., Petroleum, v. 2, iss. 1, pp. 26-39 (2016).

Due to the effects of shear history, temperature and water quality on the polymers used in “slickwater” applications, the dominant contributor to proppant transport is the velocity of the fracturing fluid moving through the created fracture. Because this is the dominant transport mechanism, initially, the maximum distance that can be propped is dependent on the proppant particles entering at the highest point of the created fracture height. This allows for the greatest distance to fall before reaching the bottom of the fracture. A higher point of entry equates to the greatest distance to fall and at a given fluid velocity will translate to those proppant being deposited the greatest distance from the wellbore. Continuing to pump proppant-laden fluid will create a settled proppant bank.

As pumping continues the settled sand bank will grow vertically and begin filling part of the created fracture volume. As the treatment continues, the settled sand bank will grow to the point that it restricts fluid movement between the top of the sand bank and top of the created fracture. There will be a point at which the velocity of the fluid flowing above the proppant bank and below the top of the fracture will be capable of picking up proppant from the top of the settled bank and carrying it out further into the created fracture. Once this condition has been achieved, it is possible to extend the propped fracture length by just continuing to pump fluid and proppant. The process in “slickwater” fracs of having to establish a settled sand bank before propping further out into the fracture forces the treatment to utilize large volumes of water and proppant to achieve the desired propped fracture penetration.

Slickwater operations use low viscosity fluid and achieve proppant transport by increased pumping rates and pressure in highly-pressurized, deeper shales/formations. Such heightened rates and pressures cause significant energy loss due to friction between tubular goods and the turbulent fluid flow. This requires extra energy (hydraulic horsepower) to compensate the energy loss. High molecular weight (typically over 10 M) polyacrylamide polymers (linear polymers that are not crosslinked) are used as friction reducers to minimize the energy loss by changing turbulent flow to laminar flow via interactions with eddies of turbulent flow.

In comparison to crosslinked fracturing fluids, slickwater used as a fracturing fluid has several advantages, including a lower cost, longer created fracture lengths, higher fracture permeability, less formation damage, and easier cleanup. The low proppant concentration, high fluid-efficiency, and high pump rates in slickwater treatments also tend to yield highly complex fractures.

The growth in the use of slickwater treatments was driven by the need to lower treatment costs but with the understanding that the formations being stimulated respond best to long narrow proppant packed fractures. Based on this understanding, the trend is to move away from viscous crosslinked fracturing fluids that primarily result in shorter and wider fractures. However, switching to fracturing designs that use thin fluid with poor proppant transport properties has forced the industry to increase fracture fluid volumes and treatment injection rates to carry and place proppant as far out into the formation as possible. Slickwater fluid can be pumped down the wellbore at rates in excess of 100 bbl/min. to fracture shale or other low permeability formations. Without using slickwater, the top speed of pumping is around 60 bbl/min. Slickwater typically uses between one and five million gallons per stimulation operation, an amount that is higher than when a gel is used.

The high pump rates for slickwater treatments necessitate the action of friction-reducing additives to reduce friction pressure by up to 70%. The positive effects of the lowered friction helps to reduce the pumping pressure to a manageable level during proppant injection. Common chemistries for friction reduction include polyacrylamide derivatives, guar, guar derivatives, and copolymers added to water at low concentrations. Additional additives for slickwater fluids may include biocide, surfactant (wettability modification), scale inhibitor, and others. The friction reduction performance of slickwater fluids is generally less sensitive to mix-water quality, a large advantage over many conventional gelled fracturing fluids. However, in high TDS water, many friction-reducing additives may not perform well. The high TDS seems to affect polymer viscosity and proppant transportation much more than drag reduction properties.

Ideally, a better result could be obtained if you could combine a relatively low viscosity fracturing fluid that creates long, thin fractures with an improved proppant transport property that was capable of maximizing the placement of proppant far out into the created fracture matrix. Such a desire gave rise to the development of the “hybrid” fracturing treatment.

A hybrid system starts with a slickwater system, transitions to an uncrosslinked polymer, and then a further transition to a crosslinked gel as the proppant concentration increases. The initial polymers are linear (uncrosslinked) gels based on uncrosslinked solutions of polysaccharides (e.g., guar, derivatized-guar, HEC, xanthan). Such fluids have viscosities of up to 30 cP at 100 sec⁻¹ at surface temperature depending on polymer concentration. This viscosity is several orders of magnitude higher than slickwater and thereby exhibit improved proppant-suspension. These uncrosslinked gels are used in late-slurry stages of a fracturing treatment after the pad and early-slurry stages used slickwater.

Proppant transport is the result of more than just viscosity and velocity. The structure of the polymer after hydration can also play a significant role. Anionic friction reducer, the most commonly used, can exhibit superior proppant transport as compared to a linear gel even if its viscosity is significantly lower. The problem is that polyacrylamide will be more adversely effected by shear history and quality of water than will be guar and guar derivatives.

It would be desirable to have a proppant transport capability like crosslinked, gel-based systems without having to utilize high viscosity, crosslinked fracturing fluids that generally create wider and shorter fracture geometry but still avoiding the need for the high pump rates and high pressures used by traditional slickwater systems and yet produce the longer, narrower fracture geometries that are characteristic of slickwater fracturing.

One fracturing technology that has been found to improve the proppant transport properties of slickwater systems is a hydrophobic proppant coating. One such coating is offered by Preferred Sands of Radnor, Pa. under the name FloPRO™. See published application US 2016/0333258. Another hydrophobic coating and its method of use are described in U.S. Pat. No. 9,234,415 using silicone oil, ethanol, organosilanes with one or more functional groups, organo-titanates, organo-zirconates, or polysiloxane. Both disclosures are hereby incorporated by reference.

The technology used to make the FloPRO hydrophobic coating appears to attract and retain gas bubbles on the surface of the coated proppant. The formation of a gas bubble layer on the proppant's surface would decrease the proppant particle's weight making it easier to suspend and transport. Thus, treatments for using the hydrophobic proppant require the presence of a gas in the slurry being pumped. The need to have a gas in the slurry requires that special high pressure pumping equipment be utilized during the pumping process to meter in the gas at a predetermined rate.

It would be desirable to have a process for fracturing and propping a subterranean formation with a low polymer system like slickwater systems but with even better transport of hydrophobically-coated proppants into the fractured formation without the need for externally introduced gas.

Additionally, the high pump rates that are characteristic of slickwater treatments translate to high shear rates for the added polymeric friction reducer as the fluid is pumped through the required series of tubes, connectors, and directional changes before the fluid reaches the downhole fracture opening. This substantial shear history has a significant, adverse, effect on the polymer structure of the friction reducer and its ability to transport proppants deeply into the fracture field. The shear degradation that the friction reduction polymers experience render many of the friction reduction polymers practically incapable of materially contributing to the transport of the proppant out into the generated fracture matrix.

It would be desirable to have a process of introducing a frac fluid having a low polymer concentration into a formation in a manner that protects the polymer and any structure that it contributes to therein from the high shear forces typically associated with polymer introduction into a formation and also be relatively unaffected by increases in the total dissolved solids (TDS) that many waters used in fracturing operations currently possess.

### SUMMARY OF THE INVENTION

It is an object of the invention to provide a process that has a proppant transport capability like the crosslinked gel-based systems but without high concentrations of high viscosity, crosslinked, fracturing fluids while also avoiding the high pump rates, high pressures and relatively low proppant concentrations that are characteristic of traditional slickwater systems.

It is further an object of the invention to provide a fracturing process that produces the longer, relatively narrow fracture geometries like those of slickwater systems but with better proppant transport of coated and uncoated proppants that result in increased propped fracture length.

In accordance with these and other objects that will become apparent from the description herein, a process according to the invention comprises a process for propping open fractures in a subterranean formation with a proppant by introducing through a wellbore and into the formation a proppant slurry that contains: (a) proppant solids in (b) a fracturing fluid wherein the fracturing fluid contains (i) less than 10 ppt of a crosslinked, friction-reducing, crosslinkable, first polymer, (ii) a delayed effect crosslinker, and optionally (iii) 0-1 ppt of a friction-reducing second polymer having a molecular weight above 15 million that is able to withstand the effects of brines having a total dissolved solids content of 50 ppm or higher.

The use of low concentrations of a crosslinked polymer provide opportunities with hydrophobically-coated proppants to reduce the cost of the well stimulation process while also providing an easier clean-up process. When used with a proppant having an affinity for micro-bubbles in the fluid and either co-introduced gas or gas generated in-situ, the coated proppants can be suspended in the frac fluid for deep penetration of the fractured subterranean field.

The benefits of the low polymer concentration crosslinked system are primarily associated with increased propped fracture length. The increased propped fracture length is the result of improved proppant transport that is achievable through a polymer structure that is less shear degradable due to delayed crosslinking and improved tolerance to high TDS. The improved proppant transport property also gives you the option (a) to lower the pump rate to gain more control over the vertical growth of the fracture thereby keeping the growth rate more contained within the targeted formation; (b) to increase proppant concentrations so that more proppant can be placed while decreasing the amount of fluid that is being pumped; (c) to transport larger proppant than can be safely placed by a slickwater frac; and (d) use a base water that contains increased TDS level of produced back water to lower the water costs.

### BRIEF DESCRIPTION OF THE DRAWINGS

FIG. 1 is a graph comparing the friction reduction effects of a high molecular weight, anionic, uncrosslinked, friction reducer to a low concentration uncrosslinked guar polymer solution.

### DETAILED DESCRIPTION OF THE INVENTION

The present invention is directed to the formation and use of proppant suspension system that is useful for proppants, both uncoated or coated, especially uncoated proppant sand and hydrophobically-coated proppants. The suspension system of the invention contains a low concentration of a first, crosslinkable, friction-reducing, polymer that can be provided with a delay in its crosslinking until the fluid is in the lower portion of the wellbore towards the fractured stratus. Preferably, the suspension system also includes a delayed onset crosslinker that controls the time delay for crosslinking of the first polymer. Also preferred is the addition of a small amount of second, friction-reducing, polymer having a high molecular weight that is able to resist the adverse effects of brine fluids having high levels of dissolved solids. This delay in substantial completion of the crosslinking protects the crosslinked polymer's structure from the adverse shear effects experienced in the pumping of the fracturing treatment through the tubular goods that connect the surface to the initiation point of the fracture.

Optionally, the proppant slurry containing the suspension system of the invention also contains a set of interacting reactants that produce gas in-situ in the proppant slurry to provide gas that is attracted to the hydrophobic coating on the proppant and thereby reduce its apparent density for easier transport within the fractured field.

The fluid of the present invention is preferably free of potassium chloride and similar cation-producing additives as well as clay and clay stabilizers.

First Friction-Reducing Polymer

Suitable crosslinkable, friction-reducing, first polymers generally comprise one or more hydratable polysaccharides, such as biopolymers like cellulose, derivatized cellulose, guar gum, derivatized guar gum, xanthan gum, galactomannan and diutan gum as well as synthetic polysaccharides like polyacrylamides or polyacrylamide copolymers. Suitable derivatized guar gums include hydroxypropyl guar, carboxymethyl guar, carboxymethylhydroxypropyl guar, and similar guar-containing compounds. These friction reducers are also preferably able to be crosslinked to increase the viscosity of the fluid and thereby enhance proppant suspension capabilities.

Suitable amounts of the crosslinkable friction reducer are lower than the amounts used in conventional gel systems and generally are used in an amount of less than 10 ppt, preferably 0.1-9 ppt, and most preferably within the range of 0.5-7 ppt.

A wide range of polymers and copolymers of friction-reducing polymers can be used in the invention including polyacrylamides, polyalkylene oxide polymers and copolymers, copolymers of acrylamide and acrylate esters, copolymers of acrylamide and methacrylate esters, copolymers of acrylamide and polymers or copolymers of ethylene oxide and/or propylene oxide, mixtures of polyacrylamide polymers and polymers of ethylene oxide and/or propylene oxide, polyvinyl acetates, vinyl sulfonic acid polymers and derivatives thereof.

A particularly preferred class of polymers are the polyacrylamides and derivatives thereof. These polymers can be obtained by polymerizing acrylamide with or without suitable comonomers to prepare essentially linear acrylamide polymers. Usually the polymerization is conducted under the influence of a chemical polymerization catalyst such as benzoyl peroxide. These acrylamide polymers are water soluble. In the instance of polyacrylamide, the polymer may be used as obtained after polymerization or the polyacrylamide may be partially hydrolyzed by the reaction thereof with a sufficient amount of a base, such as sodium hydroxide, to hydrolyze a portion of the amid groups present in the polymer molecule. Currently the guar or guar derivatives are preferred because of their shear stability in an uncrosslinked form. The polyacrylamide will be substantially degraded, even in their uncrosslinked form, by their exposure to a period of high shear.

Crosslinker

The crosslinker used in the present process may be any source of boron (such as the alkaline earth metal borates or alkali metal borates), zirconium, titanium, or any combination thereof. Salts and water soluble compounds of these materials are preferred. Preferred crosslinkers for use in the present invention are those that can exhibit a delay in the onset of crosslinking. See, e.g., U.S. Pat. Nos. 5,658,861; 5,877,127; and 6,060,436. Many boron and zirconium-based crosslinkers are commercially available as pre-formulated products for fresh water and brine systems.

Suitable amounts of crosslinker are generally used at a concentration within the range of less than 10 gallons/1000 gallons (gpt), preferably within a range of 0.1-5 gpt, and most preferably within the range of 0.25-3 gpt depending on the nature of the crosslinker, the pH of the fluid, and the amount of dissolved solids in the fluid. The active concentration of crosslinker in solution is fairly low. This is done in part to increase crosslinker volumes to a point that they can be easily metered and distributed into the fluid containing the crosslinkable polymer.

Preferably, the friction-reducing polymer and crosslinker are chosen to provide a delayed onset of the crosslinking reaction so that the friction-reducing polymer is not substantially fully crosslinked until a lower portion (e.g., the lower 50%, preferably the lower 30% and even more preferably within the lowest 5-25%) of the overall wellbore length that must be traversed by the proppant slurry before entering the fractured field of interest. The high shear forces encountered during this delay period has little effect on the uncrosslinked polymer but protects the crosslinked polymer structure from degradation so that the slurry fluid retains good suspension capacity upon entering the fractured field for deep transport of the proppant within the slurry. Techniques to delay the onset of crosslinking have been discussed in Harris et al. U.S. Pat. No. 5,372,732 (blending dry, pre-reacted gel and borate crosslinker composition with aqueous polymer solution for a delayed crosslinking as the dried composition hydrates), Kinsey et al. U.S. Pat. No. 5,565,513 (anhydrous borax or a sparingly soluble borate solution, such as anhydrous boric acid to delay crosslinking based on solubility, particle size, or pH), Qui et al. U.S. Pat. No. 5,981,446 (particulate forms of polysaccharide and metal oxides for delayed crosslinking based on hydration and dissolution rates), and Dessinger et al. U.S. Patent Publication No. 2006/0205605 (hydrated polymer and dry-blended, crosslinker/chelating agent are mixed at the ground surface of a wellsite, and subsequently injected into the formation providing controlled delay in crosslinking to achieve targeted fluid viscosity properties.)

A preferred crosslinking delay mechanism for use in the present invention includes the educated selection of crosslinker for the expected temperature, pH, water quality, and friction reducer selected to effect substantial crosslinking at or by the desired time to get downhole to the fractured field. Preferably, the crosslinking begins within the last 50%, even more preferably within the last 25% of the wellbore length between the injection point and the entrance to the fracture field. As noted above, this delay is used to protect the crosslinked friction reducer/suspension polymer structure from the degrading effects of the high shear pumping and transport operations as the fluid moves from pump to fracture field. Example 5, below, demonstrates the calculations and screening that is well within those skilled in the art with no more than an ordinary level of experience.

Optional Second Friction-Reducing Polymer

The proppant transport capacity of the dynamic fluid can be enhanced by the optional addition of 0-1, preferably 0.1-1 ppt based on the frac fluid of a second, friction-reducing, polymer composition comprising either (a) a high molecular weight, anionic, friction-reducing polymer or (b) a mixt of nonionic and amphoteric friction-reducing polymers in a ratio within the range of 1:1-5:1 (w/w), preferably within the range of 1:1 to about 3:1, even more preferably within the range of about 1:1 to about 1.5:1, and especially within a ratio of about 1:1.

One suitable second polymer is a high molecular weight, anionic, polymer that exhibits a molecular weight of above 15 million, preferably a molecular weight within the range from about 18 million to about 40 million, and even more preferably within a range from about 18 million to about 25 million. Most standard polymers useful as friction reducers for oil and gas field stimulation exhibit a molecular weight within the range of 10-12 million.

Suitable nonionic and amphoteric polymers used in the present composition preferably exhibit a molecular weight within the range of 8-14 million, preferably a molecular weight within the range from about 10 million to 15 million, and even more preferably within a range from about 10 million to about 12 million. Additional information on this mixture of friction-reducing polymers for high TDS systems is disclosed in copending U.S. patent application Ser. No. 15/786,769 the disclosure of which is hereby incorporated by reference.

Coated Proppants

The present invention is particularly well suited to proppants that have been coated with a hydrophobic coating such that the proppant surface is covered by gas bubbles that adhere to the polymer coating on the proppant grain. This gas bubble coating thus temporarily reduces the apparent density of the proppant in the frac fluid which contributes to the ability to transport the proppant further into the fractured field. With the present invention, it is possible to combine the benefits of a temporarily lowered proppant density with the improved proppant transport properties of a low polymer concentration, crosslinked, fracturing fluid. The crosslinked polymer structure improves the proppant transport of the lightened proppant particles without greatly increasing the fracturing fluid viscosity, e.g., the fluid has a viscosity of less than 100 cps, preferably less than 75 cps, and even more preferably less than 50 cps at 105 sec⁻¹. This means such an approach would result in a controlled increase in pumping fracture width, e.g., 20-30%, but a minimal loss in created fracture length. Such a change would improve the chances of pumping the fracturing treatment to completion and, at the same time, using the combination of this fracturing fluid and hydrophobically-coated proppant to significantly increase the ultimate, propped, fracture length that can be achieved. Because the improved proppant transport properties are achieved at a low polymer loading, there is also realized a reduced potential for damage to the formation or proppant pack from the breakout of a conventional fracturing fluid.

When particulate materials to be agglomerated are not inherently hydrophobic, such as silica or aluminosilicate sand, a range of different methods can be used to modify the surface of solid particles to become more hydrophobic.

Organo-silanes can be used to attach hydrophobic organo-groups to hydroxyl-functionalized mineral substrates such as proppants composed of silica, silicates and aluminosilicates. The use of organosilanes with one or more functional groups (for example amino, epoxy, acyloxy, methoxy, ethoxy or chloro) to apply a hydrophobic organic layer to silica is well known. The reaction may be carried out in an organic solvent or in the vapor phase (see for example Duchet et al, Langmuir (1997) Vol 13 pp 2271-78).

Organo-titanates and organo-zirconates such as disclosed in U.S. Pat. No. 4,623,783 can also be used. The literature indicates that organo-titanates can be used to modify minerals without surface hydroxyl groups, which could extend the range of materials to undergo surface modification, for instance to include carbonates and sulphates.

A polycondensation process can be used to apply a polysiloxane coating containing organo-functionalized ligand groups of general formula P—(CH₂)₃—X where P is a three-dimensional silica-like network and X is an organo-functional group. The process involves hydrolytic polycondensation of a tetra-alkoxysilane Si(OR)4 and a tri-alkoxysilane (RO)₃Si(CH₂)₃X. Such coatings have the advantage that they can be prepared with different molar ratios of Si(OR)₄ and (RO)₃Si(CH₂)₃X providing “tunable” control of the hydrophobicity of the treated surface.

Hydrophobic coatings can also be made with polymers having functional groups or side chains that contain aliphatic methyl, ethyl, propyl, butyl and higher alkyl homologs. Useful polymers also include those with fluoro groups that impart low surface energies and oleophobic as well as hydrophobic characteristics. Examples of such polymers include trifluoromethyl, methyldifluoro, and vinylidene fluoride copolymers, hexafluoropropyl-containing polymers, side chains that contain short chains of fluoropolymers and the like. Commercially available fluorosilicones can also be used. Examples of hydrophobic polymers include, but are not limited to, polybutadienes. Examples of such polybutadienes include, but are not limited to, non-functionalized polybutadienes, maleic anhydride functionalized polybutadienes, hydroxyl, amine, amide, keto, aldehyde, mercaptan, carboxylic, epoxy, alkoxy silane, azide, halide terminated polybutadienes, and the like, or any combination thereof. One non-limiting example includes those sold under the tradename POLYVEST (from Evonik Industries in Parsippany, N.Y.).

In some embodiments, the hydrophobic polymer may be a di-, tri-, or ter-block polymers or a combination thereof that are terminated with hydroxyl, amine, amide, mercaptan, carboxylic, epoxy, halide, azide, or alkoxy silane functionality. Examples of such diblock and triblock or terblock polymers backbone are not limited to styrene butadiene, acrylonitrile butadiene styrene, acrylonitrile butadiene, ethylene-acrylate rubber, polyacrylate rubber, isobutylene isoprene butyl, styrene ethylene butylene styrene copolymer, styrene butadiene carboxy block copolymer, chloroisobutylene isoprene, ethylene-acrylate rubber, styrene-acrylonitrile, poly(ethylene-vinyl acetate) polyethyleneglycol-polylactic acid, polyethyleneglycol-polylactide-co-glycolide, polystyrene-co-poly(methyl methacrylate), poly(styrene-block-maleic anhydride), poly(styrene)-block-poly(acrylic acid), Poly(styrene-co-methacrylic acid, poly(styrene-co-α-methylstyrene), poly(.epsilon.-caprolactone)-poly(ethylene glycol), and styrene-isoprene-styrene.

The hydrophobic coatings used on the preferred proppants for the invention appear to have an affinity for bubbles or micro-bubbles in the transport fluid. As these bubbles become associated with the hydrophobic coating, they buoy the proppant and reduce the apparent density of the coated particles thereby enhancing the suspensive effects of the fluid and allowing the proppants to be transported more deeply into the fractured field. One method of introducing such entrained gas is with high pressure nitrogen or carbon dioxide injection at the top of or at a depth within the wellbore. It is also possible to generate such gas in-situ by a chemical reaction of added components that product nitrogen or carbon dioxide as a by-product of the reaction.

Uncoated Proppants

A variety of uncoated proppants are commercially available in a range of sizes for the oil and gas industry. Suitable proppants include silica sand, glass, expanded glass, sintered ceramic, and bauxite particles. See also U.S. Pat. No. 8,227,026 the disclosure of which is hereby incorporated by reference. Proppants, whether or not coated, are often sized and sold in terms of ranges based on mesh size, e.g., 20/40 (841-420 microns), 30/50 (595-297 microns), and 40/70 (420-210 microns).

In-Situ Gas Generation

The in-situ generation of nitrogen gas volumes during formation stimulation can be accomplished by the sequential or simultaneous introduction of reactive components that generate gas as a product of their interaction. For example, sodium nitrite (as a first reactant) and ammonium chloride (as a second reactant) react or otherwise chemically interact at typical downhole conditions, e.g., 45°-100° C., and produce nitrogen and sodium chloride.

The first and second reactants should be well mixed by the time they enter the fracture field. Preferably, the time to gas generation is controlled to maximize the transport of the hydrophobic proppant into the desired locations within the fractured or fracturing field, e.g., the salts are mixed and the reaction rate has proceeded sufficiently that a sufficient amount of nitrogen is generated during the trip down that, by the time the slurry enters the fracture, the nitrogen bubble layer that reduces the proppant density is in place and helps to maximize the proppant transport within the fractured field.

It is also possible to generate carbon dioxide gas from the reaction between sodium bicarbonate and an acid. The resulting gas is generated “on the fly” during the pumping operation. This approach would utilize standard mixing and pumping equipment that the service company can readily and inexpensively make available for the fracturing treatment. This eliminates the need for a nitrogen or CO₂ service to be on site, both of which complicate the process and significantly increase overall treatment costs. The bicarbonate and acid combination is mixed and pumped with conventional equipment so that this step is much less expensive than bringing liquefied nitrogen or CO₂ to the location and pumping it with the high pressure pumping equipment. Generating the nitrogen or CO₂ by reaction would be particularly beneficial if the fracturing treatment took place in a remote area that did not have access to nitrogen or CO₂ gas or pumping equipment.

### EXAMPLES

### Example 1—Shear History Effects

To measure proppant suspension properties of a polymer (both before and after a shear history) in a dynamic test the following procedure was developed:
(a) Hydrate the polymer (to be evaluated) for 5 minutes at 1500 RPM.
(b) Add 120 gm of 20/40 coated or uncoated sand (2 pounds per gallon) and mix for 60 seconds at 1500 RPM. Note that the 120 grams would equate to 2 lb/gal if the test sample size is 500 ml.
(c) Lower RPM until sand accumulates on the bottom of the blender jar.
(d) Record the lowest RPM reading that does not cause sand accumulation.

To establish the shear sensitivity of the test sample repeat the above sequence adding a high shear step (3 minutes @ 4500 RPM) between steps (a) and (b).

Using the above procedure (both with and without including a shear history) with uncoated sand yielded the data in Table 1. The reported minimum rotations per minute (RPM) reflects the degree of dynamic movement necessary to keep the solids in suspension. The proppant is 20/40 uncoated sand.

TABLE 1

| | | Amount | | Min |
|---|---|---|---|---|
| Sample | FR | (gpt) | Shear History | RPM |
| 1.1 | A-FRE-4 | 1 | None | 530 |
| 1.2 | A-FRE-4 | 1 | 3 min at 4500 rpm | 752 |
| 1.3 | A-FRE-4 | 2 | None | 515 |
| 1.4 | A-FRE-4 | 2 | 3 min at 4500 rpm | 742 |

*The POLYglide A-FRE-4 is a high molecular weight (>15 million MW), anionic friction reducer available from PFP Industries in Houston, TX.

These test results show that a shear history resulted in a greater than 40% decrease in transport properties.

### Example 2—Shear History and Delayed Crosslinking

Using the same low polymer concentration and uncoated sand as example 1 but with a delayed onset of crosslinking had a substantial impact against degradation of the crosslinked polymer. In the following test, the uncrosslinked polymer used to create the low concentration, crosslinked, fluid of example 2 was subjected to the full shear history (3 minutes at 4500 RPM) that other samples experienced, but the onset of crosslink was delayed so that the crosslinked polymer was subjected to only 30 seconds of high shear. The system had a viscosity of 15-20 cps, we see this result in Table 2. The reported minimum rotations per minute (RPM) reflects the degree of dynamic movement necessary to keep the solids in suspension. The proppant is 20/40 uncoated sand.

TABLE 2

| Sample | FR | Shear History | Min RPM |
|---|---|---|---|
| 2.1 | Guar (7ppt) + | 3 min at 4500 RPM after | 800 |
| | 1.25 ppt | crosslinking | |
| | BBXL* | | |
| 2.2 | Guar (7ppt) + | 3 mins shear at 4500 rpm to | 494 |
| | 1.25 ppt | base polymer + 30 s at 4500 rpm | |
| | BBXL* | after crosslinking and | |
| | | then min RPM | |
| 2.3 | Guar (7ppt) + | 3 mins shear at 4500 rpm to | 539 |
| | 2 ppt BBXL* | base polymer + 30 s at 4500 rpm | |
| | | after crosslinking and | |
| | | then min RPM | |

*BBXL refers to POLYlink BBXL made by PFP Industries in Houston, TX. It is a liquid, buffered, borate crosslinker.

The test of this example shows that a high minimum RPM is required for the crosslinked polymer experiencing the full 3 minutes of high shear to maintain the 20/40 uncoated sand in suspension. This is much higher than the same material without a shear history thereby verifying that the low polymer concentration, crosslinked, system degrades under the effects of shear to the detriment of its suspension capabilities. However, the use of a delayed crosslinking time preserved the crosslinked structure and allowed the resulting crosslinked polymer structure to exhibits its suspension effects on the proppant.

As the data in Table 2 shows, delaying the onset of crosslinking accomplishes the desired goal of generating a substantial improvement in suspension capacity for proppant transport despite a low concentration of crosslinked polymer and representative shear history of the polymer-containing fluid.

For a crosslinked system to be effective, the resulting crosslinked structure (and its accompanying viscosity increase) has to be established before the fracturing fluid slurry leaves the tubular goods leading downhole and heads into the fracture field. Preferably, the crosslinking process is timed to occur in the last 25% of its residence time in the wellbore tube. This would limit the period of high shear that the crosslink structure is exposed to before the crosslinked fluid enters the relatively low shear environment that is characteristic of a fracturing fluid moving through the created fracture matrix. The crosslinked structure need not be completely formed before the slurry enters the fracture, but the crosslinking process desirably has gone far enough to have already resulted in a substantial increase in viscosity that accompanies the development of the crosslinked structure and the associated contribution to improved proppant transport.

### Example 3—Guar and Anionic FR with Coated Proppant

Example 2 established that a delayed crosslinked approach (to a 7 ppt polymer loading) could result in substantial suspension of uncoated proppant. Example 3 investigated the compatibility of the crosslinked fluid formulation to a hydrophobically-coated proppant. The first test checked the compatibility of the guar polymer to the coating technology. Tests were performed on the base guar polymer compared to the high molecular weight, anionic, A-FRE-4. All tests were performed in tap water and using 20/40 FloPRO-coated proppant sand. All tests were also subjected to a shear history of 3 minutes at 4500 RPM as representative of a shear history similar to the trip down tubular goods to the fracture.

All the tests that incorporated the guar gave a poorer static suspension result as compared to the results obtained with the additional use of the A-FRE-4 anionic friction reducer/suspension aid. This includes the Guar 4045 in the same suspension package as used in A-FRE-4. Based on these results, the high molecular weight, anionic, A-FRE-4 polymer seems to play a role in the static suspension of the coated proppant.

Guar powder (7 ppt) and 0.5 gpt A-FRE-4 were then combined and tested in the same way. The combination of the 7 ppt guar powder and 0.5 gpt AFRE-4 gave a superior suspension result with the coated proppant sand exhibiting a static suspension that was more stable over time than the test performed with 1.25 gpt A-FRE-4 alone.

To evaluate the potential to create a superior proppant transport capability by combining a hydrophobic proppant coating technology with a low concentration, crosslinked, guar, we used the combination of 7 ppt guar with a limited amount of A-FRE-4 (e.g., 0.25-0.5 gpt). The initial testing was performed at ambient conditions using tap water. The crosslinker was FLOWlink BBXL which is a buffered borate solution formulated to have an instant crosslinking effect. The test procedure will be as follows:
a. Hydrate the guar and POLYglide A-FRE-4 combination in 500 ml of tap water for 5 minutes at 1500 RPM.
b. Increase the mixer RPM to 4500, add 120 grams of proppant and maintain for 2.5 minutes. Mixing at this speed will entrain air and form micro-bubbles in solution.
c. Add FLOWlink BBXL while continuing to mix at 4500 RPM for 30 seconds. (The addition of the crosslinker in step c represents delayed crosslinking.)
d. Stop the mixer and wait 1 minute before comparing the results (Table 3).

TABLE 3

| | | | Static |
|---|---|---|---|
| Sample | Proppant | Suspension Mix | Performance |
| 3.1 | 40/70 FloPRO | 7 ppt guar + | Fully suspended |
| | | 0.25 gpt A-FRE-4 + | |
| | | 1.3 gpt BBXL | |
| 3.2 | 40/70 FloPRO | | Fully suspended, |
| | (above, after 15 mins) | | some |
| | | | agglomeration |
| | | | visible |
| 3.3 | 30/50 FloPRO | 7 ppt guar + | Fully suspended |
| | | 0.25 gpt A-FRE-4 + | |
| | | 1.3 gpt BBXL | |
| 3.4 | 30/50 FloPRO | | Fully suspended |
| | (above, after 10 mins) | | |
| 3.5 | 30/50 uncoated | 7 ppt guar + | Complete |
| | sand | 0.5 gpt anionic FR + | sedimentation |
| | | 1.3 gpt BBXL | |

The results show that with the low concentration, crosslinked polymer system of the invention and the hydrophobically-coated FloPRO coated sand, one can maintain a uniform, static, proppant distribution for at least 10-15 minutes with coated hydrophobically-coated proppants. Combining the crosslinked system of the invention with an uncoated proppant sand resulted in no static suspension effects once the mixing was stopped.

As shown in Example 4, below, static tests do not tell the whole story. Example 4 shows that the low concentration, crosslinked polymer system of the invention also has very good dynamic suspension properties for uncoated proppants as well as coated proppants. This is surprising as the traditional tests use a static suspension test in which a low concentration of polymer is unable to suspend the proppant. In a dynamic test, however, the low concentration of polymer, once crosslinked, demonstrates very good dynamic suspension properties despite having a viscosity below 100 cps at 100 sec⁻¹.

### Example 4—Brine Suspension

An important property that would be beneficial for a low polymer concentration crosslinked system to possess would be a tolerance to high TDS (total dissolved solids). High TDS occurs when brackish backwaters are re-used in the fracturing operations. The dissolved salts that are native to subterranean formations are generally not removed but returned downhole.

The anionic friction reducers that are commonly used in slickwater treatments are sensitive to high TDS fluids. The solids may not greatly affect the polymer's drag reduction properties but they can greatly reduce the solution viscosity and the full development of the polymer structure, therefore, its proppant transport properties. If a low polymer concentration crosslinked system was found to be capable of maintaining better proppant suspension properties in the presence of high TDS, this would be a very desirable property.

The following table 4 shows the results of dynamic suspension testing for a high molecular weight anionic friction reducer compared to a low polymer concentration, crosslinked, fluid system according to the invention. Each sample was subjected to a shear history of 3 minutes at 4500 RPM. Viscosity measurements are 15′ at RT and 170⁻¹. The proppant was uncoated.

TABLE 4

| | | | | | | Min |
|---|---|---|---|---|---|---|
| Sample | FR | Conc. | Xlinker | Water | Viscosity | RPM |
| 4.1 | A-FRE-4 | 4 ppt² | None | Tap | 3.7 | 752 |
| 4.2 | A-FRE-4 | 8 ppt² | None | Tap | 3.5 | 742 |
| 4.3 | A-FRE-4 | 8 ppt² | None | 50K | 1.6 | 968 |
| | | | | brine | | |
| 4.4 | A-FRE-4 | 8 ppt² | None | 100K | 1.6 | 922 |
| | | | | brine | | |
| 4.5 | — | — | — | 100K | — | 965 |
| | | | | brine | | |
| 4.6 | Guar | 7 ppt | 1.3 gpt | Tap | 19.0 | 494 |
| 4.7 | Guar | 7 ppt | none | 50K | 2.8 | 881¹ |
| | | | | brine | | |
| 4.8 | Guar | 7 ppt | 2.5 gpt | 50K | 13.0 | 509 |
| | | | | brine | | |
| 4.9 | Guar | 7 ppt | 3.0 gpt | 100K | 6.9 | 712 |
| | | | | brine | | |

¹This sample saw the full 3 minutes of high shear after crosslinking.
²The reference to 4 and 8 ppt of the AFRE-4 refers to pounds of active polymer in that sample.

The results shown in table 4 tell us at least two things. The first is that a low polymer concentration, crosslinked, friction-reduction system will provide better suspension (i.e., lower RPM to maintain suspension) of proppants with high TDS brines compared to a high molecular weight, anionic friction reducer that has been used in slickwater applications. The test data indicates that high TDS does adversely impact the reading that a 7 ppt crosslinked gel will yield on a rheometer.

While the data in a brine containing 50,000 ppm TDS is reduced by 32% (from 19 to 13 cps), the minimum RPM reading to maintain proppant suspension remains relatively constant. This is another indication that proppant transport in a low polymer concentration, crosslinked friction reducer/suspension system is probably influenced as much or more by the crosslinked polymer structure as by the pure viscosity reading.

While raising TDS to 100,000 ppm (from 50,000) does cause a 47% drop in viscosity as compared to the reading for a 50K brine, the resulting minimum RPM value is still well below that attained with A-FRE-4 alone.

The second indication is that the crosslinked fluid without the addition of a second friction reducer in both freshwater and brines (samples 4.6, 4.8, and 4.9) all show improvements in dynamic suspension properties compared to the control (sample 4.5) and to the conventional, high molecular weight, anionic friction reducer, e.g., by comparing sample 4.6 (494 RPM in tap water) with samples 4.1 (752 RPM) and 4.2 (742 RPM) and sample 4.8 (509 in 50 k brine) with sample 4.3 (968 RPM).

### Example 5 Effects of Delayed Crosslinking

This example simulates the delayed onset of crosslinking in a 7 ppt, crosslinked, guar system according to the invention.

With suitable calculations, the fluid velocity in a 4 inch pipe introduced at the rate of 40 barrels per minute is 46.75 ft/s. If the distance the frac fluid has to travel to get from the surface to the fracture opening is 8500 ft, then the time spent in the tubing is 182 seconds. For an intended delay to reach a crosslinked viscosity by the time it takes the frac fluid to travel 75% of the distance in the pipe (i.e., within the last 25% of the wellbore distance to be traversed), this delay would be 136.35 seconds or 2 minutes and 16 seconds.

The combination of temperature, pH, crosslinker, and additive concentration in Table 5 would be of interest to the desired effects.

TABLE 5

| Condition | Value |
|---|---|
| Temp (° F.) | 200 |
| Crosslinker | DXL2* |
| pH control (gal/1000 gals) | 1 |
| Crosslinker (gal/1000 gals) | 1.5 |
| pH | 11.26 |
| Viscosity (cps@ 100 sec−1) | |
| at 1.5 min | 77 |
| at 2 min | 95 |
| at 2.5 min | 126 |

*DXL2 refers to POLYlink DXL-2, an aqueous, delayed, borate crosslinker from PFP Technology in Houston, TX.

Note: The test temperature simulates the formation temperature. The fluid sample starts at room temperature and heats up to a maximum of 200° F. As the test time increases the temperature of the test sample is increasing (simulating the heat up that occurs while the fluid is being pumped downhole and out into the fracture).

The same type approach would be used with the low polymer concentration, crosslinked system except that the viscosity reading that symbolized crosslinking would be much lower (probably some multiple of the base viscosity of the 7 ppt guar polymer). For example if the base viscosity was 3 cps, we would say reaching a viscosity of 12-15 denotes a crosslinked structure has been developed. But we would still calculate the time spent going down the pipe and target (reaching a crosslinked structure) about ¾ of the way down the pipe.

### Example 6—Air Exclusion Test

Example 6 uses nitrogen created through the reaction of two salt in solution “on the fly” to test the functionality of this method during proppant pumping operations. This approach will utilize standard mixing and pumping equipment that the service company can readily and inexpensively make available for the fracturing treatment. This eliminates the need for a nitrogen service to be on site which both complicates the treatment's execution and significantly increases overall treatment costs. The salt solutions that are mixed and pumped with conventional equipment could be much less expensive than bringing liquefied nitrogen to the location and pumping it with the high pressure nitrogen pumping equipment.

To show the validity of this approach, we will utilize the same suspension test procedure that was used in the prior examples. The procedure is as follows:

a) Add the friction reducer (to be incorporated in the suspension test) to 500 ml of water and mix for 5 minutes at 1500 RPM.

b) Add 120 gm of the FloPRO sand to be evaluated into the blender containing the sample from Step #1 and mix at 4500 RPM for 3 minutes. This concentration represents a proppant concentration of 2 pounds per gallon. The mixing step is representative of the high shear trip though tubular goods before reaching the fracture.

c) After the three minutes of shear/mixing stop the blender and let stand for 1 minute.

d) After completion of 1 minute period photograph the sample to record the suspension results and estimate the amount of suspended particles as a percentage of the proppant sample added in Step #2.

In this procedure, the high speed mixing step results in air being sucked into the blender and mixed with the slurry. The presence of the air in place of the nitrogen in the slurry is used to form a bubble layer on the proppant surface area. It is the establishment and the retention of this bubble layer that is believed to allow the proppant to remain suspended when the mixing of the sample is stopped. The blender jar is left uncovered and thereby free to entrain air into the sample. The sample volume is selected so that the fluid and sand fills no more than approximately half the volume of the blender jar. Using too big a sample relative to the size of the blender jar will restrict the amount of air that will be mixed into the sample and eventually used in the bubble layer.

A test of the suspension test procedure above was done with 30/50 mesh FloPro hydrophobically-coated sand and 1 gpt POLYglide A-FRE-4 high molecular weight friction reducer/suspension agent in tap water (low TDS). After shearing/mixing at 4500 RPM, this sample showed 100% suspension of the 30/50 FloPRO coated particles.

The test was repeated keeping all aspects of the test unchanged except that the volume of tap water was increased from 500 ml to 900 ml. At the greater volume of water, there was minimum space between the fluid level in the jar and the top of the blender jar. Also during the test there was a lid placed on the jar to minimize the amount of air that was available to be sucked into the test sample. The goal of this test was to establish the need to have air sucked into the blender during the high speed portion of the mixing so that gas was available to form the bubble layer on the sand particle's surface area that results in the sand staying suspended after mixing is completed. This altered procedure the test was repeated still utilizing 1 gpt POLYglide A-FRE-4 and 30/50 FloPRO coated sand.

Limiting the availability of air during high speed mixing resulted in almost none of the FloPRO coated particles being suspended after mixing had stopped.

### Example 7—Nitrogen Generation In-Situ

To illustrate the utility of generating gas to form a bubble layer that leads to the suspension of the proppant grains, the altered procedure that led to no suspended particles in Example 6 was used but with the generation of a nitrogen gas formed in-situ from the reaction of 86 grams of ammonium chloride and 110.9 grams of sodium nitrite. These weights represent an equal mole ratio of the two components. The reaction between the two salts was catalyzed by the addition of 5 grams of acetic acid. The test procedure is as follows:

a) The sample volume was 900 ml of tap water that was split into two components.

b) A 700 ml portion was used to hydrate 1 gpt POLYglide A-FRE-4 as well as contain the ammonium chloride and acetic acid.

c) The sample was mixed for 5 minutes at 1500 RPM.

d) After a 5 minute period used to hydrate the friction reducer, a 200 ml portion of water containing the sodium nitrite and 120 grams of FloPRO 30/50 mesh sand are added while increasing the mixer speed to 4500 RPM. The blender lid was held tightly in place on the mixer.

e) At the end of 3 minutes, the 4500 RPM mixing was stopped and the suspension of particles observed.

The test showed that the generation of the nitrogen from a reaction of salts can provide sufficient gas to facilitate the suspension of virtually all of the FloPRO coated 30/50 sand. It was also observed that the reaction continued for approximately one hour which is a time that is like the pumping time associated with a stage of a fracturing treatment so the effect has the ability to work in an actual fracturing operation. The ongoing availability of nitrogen to replace any uncovered surface area that might be exposed during the pumping operation was felt to be an added benefit.

### Example 8—Carbon Dioxide Generation In-Situ

In this example, the CO₂ available to form the bubble layer on the FloPRO coated sand grains was generated from the reaction between 2.25 grams of sodium bicarbonate and 6.51 grams of 15% (by weight) hydrochloric acid. These weights represent an equal mole ratio of the two components. A lid is taped onto the mixing jar to make an air tight seal to make sure any bubbles are the result of generated CO₂ gas. The friction reducer(s) and the hydrophobically-coated proppant are then added through a removable stopper located in the center of the lid. The test procedure is as follows:

Sample A of 800 ml was used to hydrate 1 gpt of an anionic friction reducer (POLYglide A-FRE-4). This solution was mixed for 5 minutes at 1500 RPM to hydrate the friction reducer. After the 5 minute period, a 100 ml portion of water containing the sodium bicarbonate and 120 grams of FloPRO 30/50 sand was added while increasing the mixer speed to 4500 RPM with the blender lid held tightly in place. While mixing, the stopper was removed to add the acid (6.51 g of 15% HCl) and immediately replaced to create an air tight seal. At the end of 3 minutes, the mixing at 4500 RPM was stopped and the suspension of particles observed at one minute after mixing was stopped.

The test showed complete suspension of the hydrophobically-coated proppant solids. Thus, the generation of the CO₂ gas from a reaction between sodium bicarbonate and mineral acid can provide sufficient gas to facilitate the suspension of all of the FloPRO-coated 30/50 sand. The reaction between the bicarbonate and acid is instantaneous so the CO₂ bubble layer on the coated proppant surface will be formed well before the slurry reaches the fracture.

### Example 8—Friction Reduction

There are two more fracturing fluid characteristics that would be important for a low concentration crosslinked polymer system to exhibit if it was going to be used in place of a friction reducer polymer in a slickwater fracturing fluid. The first such characteristic is drag reduction. The one thing a friction reducer does well is reduce pipe friction that is created when the fracturing fluid and proppant are pumped through tubular goods. The conventional industry-accepted way to determine the amount of drag reduction that a friction reducer can create is with a device described as a flow or friction loop. It contains a pump and a length of pipe with pressure taps that have been designed to allow the fluid velocity in the test to be representative of what is achieved in a fracturing treatment. By monitoring the pressure drop in the test section and comparing the test results of pumping water with and without a friction reduction polymer, one can calculate the expected drag reduction that the polymer can achieve. If the delayed crosslinking of a low concentration polymer is to be effective in replacing a friction reducer in a slick water treatment, it needs to yield similar drag reduction results before the polymer is crosslinked.

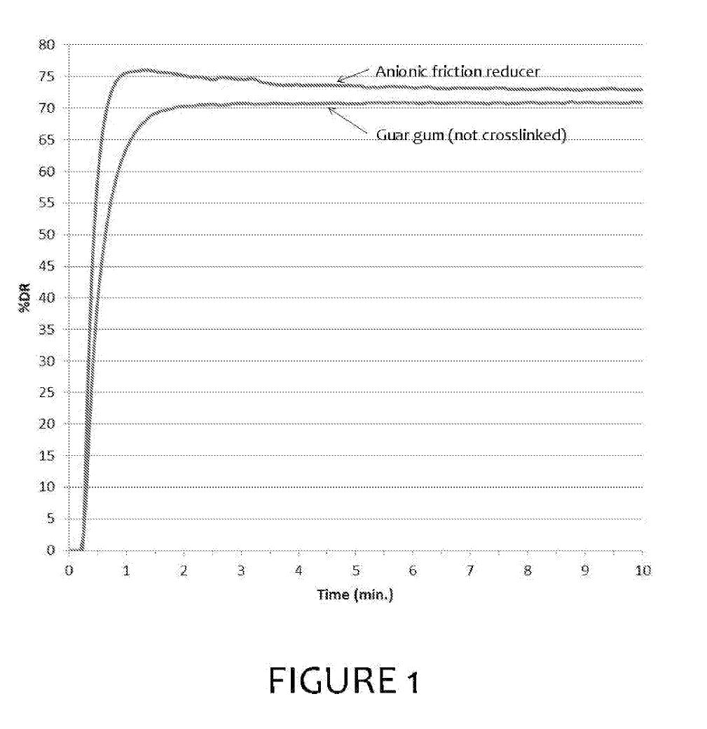

FIG. 1 shows the drag reduction (DR) of a high molecular weight, anionic, friction reducer compared to a 7 ppt guar gum system having a linear gel structure before crosslinking. The anionic FR is 4 ppt PolyGLIDE A-FRE-4 (1 gallon per thousand (gpt) corresponds to 4 parts per thousand (ppt)). The guar gum system contains 7 ppt (1.75 gpt equals 7 ppt). Both are in tap water in a pipe of 0.25 inches diameter at 12 gallons per minute flowrate.

The drag reduction results in FIG. 1 confirm that the un-crosslinked guar gum polymer solution gives very similar test results to a friction reducer that is conventionally used in slickwater treatments.

The disclosures of all patents and published applications discussed or disclosed herein are incorporated by reference.

What is claimed is:

1. A process for propping open a fractured subterranean formation with a proppant slurry introduced down a wellbore length and into the fractured subterranean formation, said proppant slurry comprising:
(a) proppants in
(b) a transport fluid that contains (i) 0.1 to less than 10 ppt of a first friction-reducing, crosslinkable, polymer, (ii) a crosslinker having a delayed crosslinking effect, and (iii) 0-1 ppt of a second friction-reducing polymer composition having a molecular weight above 15 million.

2. A process according to claim 1 wherein said first friction-reducing polymer comprises an hydratable polysaccharide.

3. A process according to claim 2 wherein said polysaccharide comprises a cellulose, derivatized cellulose, guar gum, derivatized guar gum, xanthan gum, or diutan gum.

4. A process according to claim 1 wherein said first friction-reducing polymer becomes substantially fully crosslinked in a last 50% portion of the wellbore length as said slurry proceeds to said formation.

5. A process according to claim 1 wherein said second friction-reducing polymer composition comprises an anionic polyacrylamide polymer.

6. A process according to claim 1 wherein said second friction-reducing polymer composition comprises a mixture of an anionic and nonionic friction-reducing polymers in a ratio within the range of 1:1 to 5:1.

7. A process according to claim 1 wherein said second friction-reducing polymer composition comprises a mixture of an anionic and amphoteric friction-reducing polymers in a ratio within the range of 1:1 to 5:1.

8. A process according to claim 1 wherein said proppants have a hydrophobic coating.

9. A process according to claim 1 wherein the proppant slurry further comprises reactants that will react to form gas in-situ within said slurry.

10. A process according to claim 9 wherein the produced gas is nitrogen or carbon dioxide.

11. A process according to claim 1 wherein said proppants are uncoated.

12. A proppant slurry that comprises (a) 0.1 to less than 10 ppt of a friction-reducing, crosslinkable, first polymer, (b) a crosslinker having a delayed crosslinking effect, and (c) 0.1-1 ppt of a friction-reducing second polymer having a molecular weight above 15 million that is able to withstand the effects of brines having a total dissolved solids content of 50 ppm or higher.

13. A proppant slurry according to claim 12 wherein said first polymer comprises a cellulose, derivatized cellulose, guar gum, derivatized guar gum, xanthan gum, or diutan gum

14. A proppant slurry according to claim 12 wherein said second polymer is an anionic polyacrylamide.

15. A proppant slurry according to claim 12 wherein said proppant slurry further comprises reactants that will react to form gas in-situ within said slurry.

16. A proppant slurry according to claim 15 wherein the produced gas is nitrogen or carbon dioxide.

17. A process for propping open a fractured subterranean formation with a proppant slurry introduced down a wellbore length and into the fractured subterranean formation, said proppant slurry comprising:
(a) proppants in
(b) a transport fluid that contains 0.1 to less than 10 ppt of a first friction-reducing, crosslinkable, polymer.

18. A process according to claim 17 further comprising a crosslinker having a delayed crosslinking effect, said crosslinker comprising a source of boron, zirconium, or titanium.
